(19) United States
(12) Patent Application Publication
(10) Pub. No.: US 2025/0180516 A1
(43) Pub. Date: Jun. 5, 2025

(54) Mixture Monitoring

(71) Applicant: Tribosonics Limited, Sheffield (GB)

(72) Inventors: Louis Scholes, Sheffield (GB); Samuel Joseph Hill, York (GB); Philip Harper, Newcastle (AU); Jack Sands, Sheffield (GB)

(21) Appl. No.: 18/843,971

(22) PCT Filed: Mar. 2, 2023
(86) PCT No.: PCT/GB2023/050472

§ 371 Date: Sep. 4, 2024

(30) Foreign Application Priority Data
Mar. 4, 2022 (GB) 2203056.3

(51) Int. Cl. G01N 29/024; G01N 29/032; G01N 29/036; G01N 29/22; G01N 29/34; G01N 29/44

(52) U.S. Cl. CPC G01N 29/024; G01N 29/032; G01N 29/036; G01N 29/222; G01N 29/341; G01N 29/4436; G01N 2291/0222; G01N 2291/02809; G01N 2291/02872; G01N 2291/02881

(57) ABSTRACT

A method for monitoring a mixing ratio of a mixture of materials flowing through a conduit in a composite material production process. The conduit is arranged between an inlet for receiving the mixture and a curing assembly. The method comprises: obtaining an acoustic signature of the mixture of materials; controlling a transducer to emit an acoustic wave into the conduit; controlling a receiver to detect the acoustic wave after propagation of the acoustic wave through the conduit; and comparing an acoustic signature of the detected acoustic wave with the obtained acoustic signature to obtain monitoring data.

### FIELD OF INVENTION

Monitoring the mixing ratio of a mixture comprising multiple materials, particularly, mixtures that cure to form composite solid materials.

### BACKGROUND

Many critical components in machinery such as turbines, aeroplanes, cars, and boats are manufactured from composite materials. These components can be formed by injecting a liquid mixture into a mould. The liquid mixture cures due to a chemical reaction between agents within the mixture thus forming a solid component. In order for the solid component to be properly formed and free of defects it is critical that the mixing ratio of agents within the mixture is correct. Currently, the mixing ratio is verified post curing, by which time the component has already been formed and remedial action has become costly. Alternatively, the material may be manually inspected by stopping production, which is disruptive and expensive. Furthermore, it is difficult to ascertain if the mixing ratio is even across the material that has been dispensed into a mould. There is required a need for an improved method of monitoring mixing ratios of agents within a mixture.

### SUMMARY

According to a first aspect there is provided a method for monitoring a mixing ratio of a mixture of materials flowing through a conduit in a composite material production process. The conduit is arranged between an inlet for receiving the mixture and a curing assembly. The method comprises: obtaining an acoustic signature of the mixture of materials; controlling a transducer to emit an acoustic wave into the conduit; controlling a receiver to detect the acoustic wave after propagation of the acoustic wave through the conduit; and comparing an acoustic signature of the detected acoustic wave with the obtained acoustic signature to obtain monitoring data.

Optionally, the acoustic signature comprises an individual acoustic signature for each of the materials from the mixture of materials.

Optionally, the acoustic signature is a value for the time of flight of the acoustic signal, and the step of comparing comprises comparing values of the time of flight of the detected acoustic wave with an obtained time of flight.

Optionally, the step of comparing comprises comparing values of acoustic attenuation derived from the detected acoustic wave and the obtained acoustic signature.

Optionally, the step of comparing comprises comparing a frequency spectrum derived from the detected acoustic wave and the obtained acoustic signature.

Optionally, the step of controlling a transducer to emit the acoustic wave comprises emitting one or more of an acoustic pulse and a continuous acoustic wave.

Optionally, the transducer and receiver are a singular transceiver, the acoustic wave being emitted by the transceiver to be reflected from an interior wall of the conduit back to the transceiver.

Optionally, the transducer is controlled to transmit the acoustic wave to the receiver through the flowing mixture of materials.

Optionally, the transducer is controlled to emit the acoustic wave across an outer wall of the conduit to the flowing mixture therein.

Optionally, the receiver is controlled to detect the acoustic wave at each of a plurality of measurement time intervals. Optionally, the method further comprises determining a mean parameter or average parameter of the acoustic wave across the plurality of measurement time intervals for comparison with the acoustic signature.

Optionally, the method further comprises determining a value of the mixing ratio based on the monitoring data.

Optionally, the method further comprises controlling a pressure sensor to detect the pressure of the mixture of materials and wherein the value of the mixing ratio is additionally determined based on the detected pressure.

Optionally, the method further comprises controlling a temperature sensor to detect the temperature of the mixture of materials and wherein the value of the mixing ratio is additionally determined based on the detected pressure.

Optionally, the acoustic wave is emitted into the conduit at a location proximal the curing assembly.

Optionally, the mixture of materials comprises a resin and a catalyst for curing in the curing assembly to a solid composite component.

Optionally, the step of obtaining an acoustic signature comprises emitting a test acoustic wave through each of the materials comprising the mixture of materials and receiving corresponding acoustic waves defining the acoustic signature.

Optionally, the method further comprises the step of transmitting the monitoring data to a remote processing device.

According to a further aspect of the invention there is provided a computer program comprising instructions which, when the program is executed by the processor, cause the processor to carry out the method discussed above.

According to a further aspect of the invention there is provided a computer-readable medium comprising instructions which, when executed by a processor, cause the processor to carry out the method discussed above.

According to a further aspect of the invention there is provided an assembly arranged to monitor a mixing ratio of a mixture of materials flowing through a conduit in a composite material production process. The conduit is arranged between an inlet for receiving the mixture and a curing assembly. The assembly comprises: a transducer arranged to emit an acoustic wave into the conduit; a receiver arranged to detect the acoustic wave after propagation of the acoustic wave through the conduit; and a processor arranged to compare an acoustic signature of the detected acoustic wave with an earlier obtained acoustic signature to obtain monitoring data.

Optionally, the transducer is arranged to emit one or more of an acoustic pulse and a continuous acoustic wave.

Optionally, the transducer and receiver are a singular transceiver.

Optionally, the transducer and receiver are spatially separated from each other along the circumferential and/or the longitudinal direction of the conduit.

Optionally, the assembly further comprises a plurality of transducers and/or receivers distributed along the conduit.

Optionally, the conduit is arranged between a mixing assembly and the curing assembly.

### BRIEF DESCRIPTION OF FIGURES

FIG. 1 is a flow diagram indicating a method according to this disclosure.

FIG. 2 is a diagram of an assembly according to this disclosure and which is suitable for performing methods according to this disclosure.

FIGS. 3 to 5 are diagrams indicating example alternative locations of transducers and receivers of the apparatus of FIG. 2.

FIG. 6 is a diagram indicating example alternative locations of transducers/receivers of the apparatus according of FIG. 2.

FIGS. 7 and 8 indicate example locations of transducers and receivers in relation to a conduit of an apparatus according to this disclosure.

FIG. 9 is a plot of test results showing a relationship between measured time of flight through a mixture and the mix ratio of the mixture.

FIG. 10 is a plot of test results for the test of FIG. 9 showing time of flight for various 60 second time periods that each correspond to a different mix ratio.

FIG. 11 is a plot of test results for the test of FIG. 9 showing a close-up of the variation of pressure within the mixture with time.

FIGS. 12 to 15 are plots of acoustic waveforms utilised for determining time of flight measurements.

### DETAILED DESCRIPTION

The quality and precise mixing ratio of components determine the performance characteristics of a composite material when it is set. At a first stage of a process, two or more components are mixed, typically in a fluid phase. The mixed fluid is then transported through a conduit to a site such as a casting mould where the mixed fluid is allowed to set. Even if the initial ratio of components is exactly the ratio required for a chemical process to take place, the mixture may be unstable during transport through the conduit. There may be multiple reasons for unstable conditions: the chemical reactions will already start during the movement of the fluid through the conduit, the temperature may change during transport due to the chemical reaction, and air bubbles may form due to leak paths in the assembly. The inventors have realised that a mixed fluid has a unique acoustic signature, and that the process can be monitored and controlled by monitoring the acoustic properties of the fluid during movement through the conduit. When a deviation from a signature is detected, the mixing process can be adjusted or an alarm can be raised.

A specific example of a curing process is the mixing of a resin and a catalyst. A more specific example is a polyurethane, such as polyester or polyether. The catalyst, sometimes also called a hardener, determines the speed of the curing process. Polyurethanes are produced by mixing diisocyanates with polyols, together with the catalyst. A particular application of resins is in the production of wind turbine rotor blades. The resin may be reinforced with fibreglass, and drawn into a cast by low pressure. A consistent strength of the material is particularly important in the application of turbine blades because the repeated strain and stress during use are typically large, and the high risks involved in any failure. The turbine blades are typically also large, with diameters of the rotor of well over 100 m. If a mistake in the mixing ratio is determined after the resin has entered the cast, then possibly the entire blade needs to be discarded. The inventors have therefore created a setup where the mixed fluid properties are determined in the conduit before entering the cast, with the option to interrupt the casting process if a deviation is determined and prevent an incorrectly mixed resin from entering the cast.

The invention is not limited to the specific example discussed above. Embodiments of this disclosure can be applied to the monitoring of mixing ratios of mixtures of materials for a variety of different applications such as for producing components for aircraft or boats.

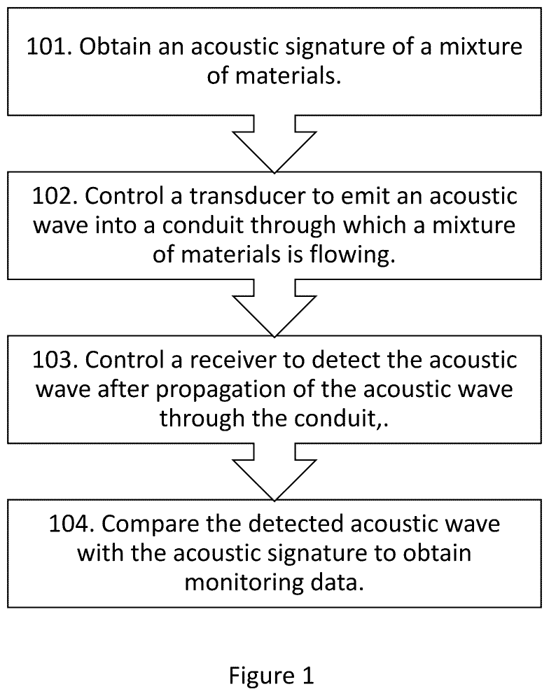

With reference to FIG. 1, there is a method according to this disclosure for monitoring a mixing (or mix) ratio of a mixture of materials flowing through a conduit in a composite material production process such as the formation of a solid fibreglass-reinforced polyester or epoxy component. The conduit is arranged between an inlet for receiving the mixture and a curing assembly. The inlet may be configured to receive the mixture from a mixing assembly that typically comprises a mixing chamber for mixing a resin and a catalyst together for forming the mixture and/or a container comprising a pre-mixed mixture. The mixture is typically in liquid form as it flows through the conduit. The curing assembly typically comprises a mould suitable for receiving the mixture in order that the mixture cures and solidifies into a desired shape. The mixture may be dispensed into the mould from the conduit via a nozzle. An example apparatus for undertaking the method will be discussed in more detail during later parts of this disclosure.

The method steps discussed below are typically undertaken by an electronic controller having a processing means and being capable of controlling an acoustic transducer and receiver. The controller may control the transducer by emitting electronic signals that are converted to acoustic energy by the transducer. During step 101 an acoustic signature of the mixture of materials is obtained. The acoustic signature may be stored as electronic data having been obtained during previous calibration method (not shown). Alternatively, the acoustic signature may be obtained during the method of this disclosure. The acoustic signature may comprise an acoustic measurement of the mixture of materials. The acoustic signature may comprise an individual acoustic signature for each of the materials comprising the mixture of materials. For example, the acoustic signature may comprise a predetermined speed of sound through each of the resin and the catalyst. The method may comprise a calibration or test step including obtaining an acoustic signature for each of the materials comprising the mixture of materials by emitting a test acoustic wave through each of the materials and receiving corresponding acoustic waves defining the acoustic signature for each of the materials. The acoustic signature may be determined based on a mathematical model.

During step 102, the transducer is controlled to emit an acoustic wave into the conduit through which the mixture of materials is flowing. The acoustic wave may be emitted such that the wave traverses through a portion of the mixture within the conduit. Alternatively, the acoustic wave is emitted such that the wave interacts with a phase boundary between a wall of the conduit and the mixture of materials, without necessarily traversing through the mixture itself. The acoustic wave can be emitted into the conduit via transmission through a wall of the conduit, or, directly into the mixture of materials. The acoustic wave may be any of a pulse echo, a through wave a continuous wave, a tone burst, a chirp, and a pitch-catch.

During step 103, the receiver is controlled to detect the acoustic wave after propagation of the acoustic wave through the conduit. As used herein “propagation of the acoustic wave through the conduit” may refer to propagation of the waves through the material flowing within the conduit. The waves may propagate across the conduit in a direction substantially perpendicular to the flow of the material and/or in a longitudinal direction along the flow of the material. The detected acoustic wave may be reflected from an interior wall of the conduit. The transducer and the receiver may be a single transceiver device in which case the acoustic wave is emitted and received at the same location. Alternatively, the transducer and the receiver are separate devices located longitudinally along the conduit and/or located on opposite sides of the conduit. In the latter instance, the acoustic wave can pass through the flowing mixture from the transducer to the receiver without being reflected. The receiver may be controlled to detect the acoustic wave at a plurality of measurement time intervals. The measurement time intervals may be at a range from 0.1 Hz to 20 kHz, and has been found to be favourable at 160 Hz. In this case, a mean/median parameter of the acoustic wave across the plurality of measurement time intervals may be determined for comparison with the acoustic signature. The transducer may be controlled to emit a separate acoustic wave into the conduit for detection by the receiver at each time interval.

During step 104, the detected acoustic wave is compared with the acoustic signature to obtain monitoring data that is typically representative of the mixing ratio of different materials within the mixture. The comparing may comprise undertaking a calculation based on variables of the acoustic signature and detected acoustic wave in order to determine the mixing ratio of different materials within the mixture. Example variables include the speed of sound and acoustic attenuation. Furthermore, frequency spectra derived from the acoustic signature and/or the detected acoustic wave (e.g. via a Fast-Fourier-Transform (FFT) analysis) can be utilised for the comparison. Based on the monitoring data, it is possible for a user to ensure that the mixing ratio remains within an acceptable tolerance band. The user may monitor the data for any change indicative of an incorrect mixing ratio. The user may be provided with a numerical value (e.g. in %) of the mixing ratio of different materials within the mixture.

Additionally, not shown in FIG. 1, the method may comprise controlling a pressure sensor to detect the pressure of the mixture of materials. The method may also comprise controlling a temperature sensor to detect the temperature of the mixture of materials. The obtained values of temperature and/or pressure may be utilised with the comparison in step 104 of FIG. 1. Other sensors such as a colour sensor and electrical property sensor (e.g. for measuring capacitance, inductance, and impedance) may further be controlled to detect corresponding variables relating to the mixture of materials for use during the comparison step 104 of FIG. 1.

The method of FIG. 1 is particularly suitable for use with a mixture of liquid materials comprising a resin and a catalyst for curing in the curing assembly to a solid composite component. Using the method discussed above, it is possible to monitor the mixing ratio of resin and catalyst to ensure that the mixture is at an optimal state for curing properly within the mould so as to be substantially free of defects. It would be appreciated that defects arising from improper mixing of resin and catalyst can be expensive to rectify after the mixture has cured and may require replacement of an entire component.

Any of the steps discussed above may be undertaken by a controller that is local to the transducer. Alternatively, the controller may be remote to the transducer and perform the method steps via remote control over a network. The step of comparing 104 may be undertaken remotely to the transducer, e.g. on a cloud computing server. In this case, data representative of the acoustic signature and acoustic wave is transmitted and/or stored on the cloud computing server via a network.

An assembly arranged to monitor a mixing ratio of a mixture of materials that utilises the method of the present disclosure is now described.

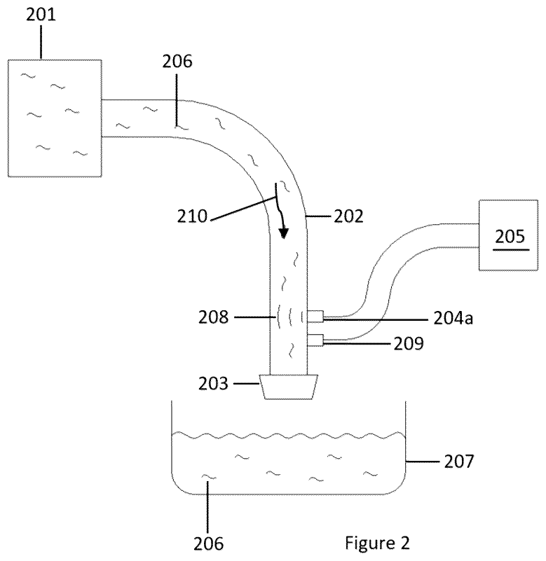

With reference to FIG. 2, a liquid mixture 206 flows through a conduit 202 in the direction of arrow 210. The mixture 206 may have an alternative phase such as being in a solid powder form. The conduit 202 may be supplied by a mixing assembly 201. The mixing assembly 201 may be separated from the conduit 202. For example, the mixing assembly 201 may be located remotely to the conduit with the liquid mixture 206 being transferred from the mixing chamber 201 to an inlet of the conduit 202. The inlet may be part of the conduit, and the inlet may or may not be fluidly connected to the mixing assembly 201. Optionally, the conduit 202 directs the mixture to a nozzle 203 for dispensing the mixture. Typically, the mixture comprises materials including a liquid epoxy resin and a catalyst or hardener. These materials may be simply referred to as a resin and a catalyst. The mix ratio of the component substances is preferably such that they chemically react with one another in order to form a solid composite component during a curing process that completes after dispensation from the conduit 202 into a curing assembly 207. The curing process may be a thermal curing process involving the curing assembly 207 being heated e.g. in an oven (not shown) for initiating and completing the curing. The shape of the solid object is typically defined by the shape of the curing assembly 207 such as a mould within which the liquid mixture 206 has been poured via the nozzle 203. In examples, the curing assembly 207 is shaped to so that the mixture cures to form a composite wind turbine blade. It would be appreciated that it is important for the composite component to be correctly formed to reduce the risk of failure during use. Therefore, the mix ratio of the component substances must be correct and uniform across all of the mixture 206 that is poured into the mould 207. The methods and apparatus of this disclosure provide for the mix ratio of the mixture 206 to be monitored in real-time before dispensing by the nozzle 203 thereby providing assurance of proper formation of the solid composite component in the curing assembly 207.

With continued reference to FIG. 2, a transducer 204a is attached to a side of the conduit 206. Preferably, the transducer 204a is mounted non-invasively with respect to the flowing mixture 206. The transducer 204a may be mounted to be in direct contact with the flowing mixture 206, or on an outer surface of the wall of the conduit 202. The transducer 204a is configured to emit an acoustic wave 208 across the conduit. The term “across the conduit” typically refers to a distance crossing a portion of a cross section of the conduit that may or may not be perpendicular to the direction of flow of the mixture 206. In the example of FIG. 2, the acoustic wave 208 is reflected by the wall of the conduit 208 and detected by the transducer 204a acting as a receiver. In the example of FIG. 2, the transducer and receiver are a singular transceiver 204a. Other possible arrangements of the transducer and the receiver are discussed below. A pressure sensor 209 may be arranged to detect the static pressure of the mixture 206 at a location proximal to the acoustic wave 208. A temperature sensor (not shown) may be arranged to detect the temperature of the mixture 206 at a location proximal the acoustic wave 208. A processor 205 is arranged to compare the received acoustic wave 208 with an earlier obtained acoustic signature to obtain monitoring data. The earlier obtained acoustic signature may be stored in electronic memory attached to the processor 205 and/or obtained by the same apparatus of FIG. 2 and undertaking any of the methods discussed above.

With continued reference to FIG. 2, in one example the transducer 204a measures a time of flight of the acoustic wave 108 that has travelled through the mixture 206. The controller 205 may determine the time delay between emitting and receiving a pulse of the acoustic wave 208. Alternatively, the controller may obtain a level of attenuation of the acoustic wave 208 during travel through the mixture 206.

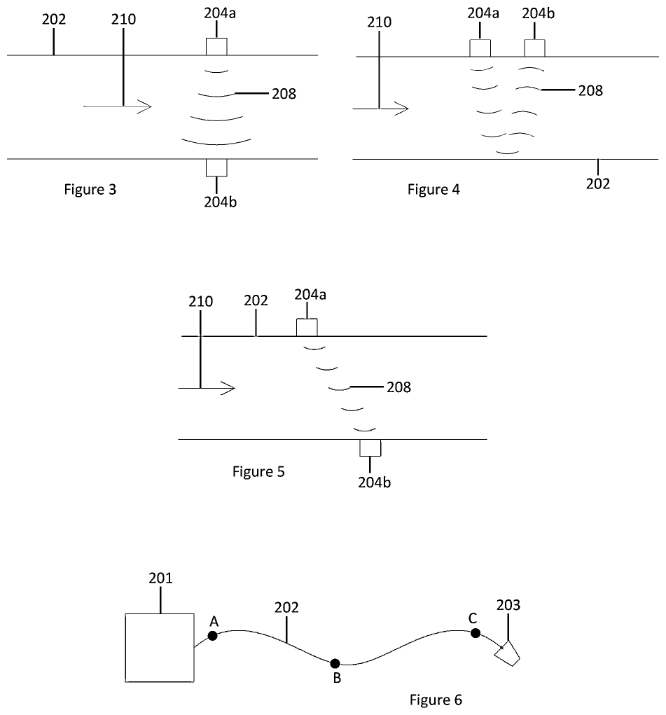

With reference to FIG. 3 there is an alternative arrangement to that of FIG. 2, whereby there is a receiver 204b which is a separate device to the transducer 204a. The transducer 204a and receiver 204b may both be identical components, but each undertake the different functions of emitting and receiving. In the example of FIG. 3, the wave 208 is transmitted from transducer 204a to receiver 204b.

With reference to FIG. 4 there is yet another alternative arrangement comprising a transducer 104a and a receiver 104b that are spatially separated from each other along a longitudinal direction of the conduit 202. The receiver 104b is located on the same side of the conduit 102 as the transducer 104a and relies on the acoustic wave 108 being reflected from the wall of the conduit 102.

With reference to FIG. 5 there is yet another alternative arrangement comprising a transmitting transducer 204a and a receiving transducer 104b that are separated from each other both in a circumferential and longitudinal direction of the conduit 202. The receiving transducer 204b is located on an opposing side of the conduit 202 as the transmitting transducer and relies on the acoustic wave 208 being transferred downstream by the flow of the mixture through the conduit for reception by the receiver 204b. Although not shown, there may be more than two transducers and/or receivers distributed along the conduit 202.

The term “transducer” as used herein may refer to a device capable of concerting electrical energy to acoustic energy and vice versa. Where a transducer is described as emitting waves, the transducer may be solely an acoustic emitter or speaker. Where the transducer is described as receiving waves, the transducer may be solely an acoustic receiver or microphone. Where a transducer is described as emitting and receiving soundwaves, the transducer may act as both an acoustic emitter and receiver.

With reference to FIG. 6, the transducer arrangement discussed above may be located at any of locations A, B, or C along the conduit 202 in relation to the mixing chamber 201 (or inlet) and the nozzle 203. It is particularly advantageous for the transducer arrangement to be closer to the nozzle 203 than to the mixing assembly 201/(or substantially adjacent to the nozzle 203 at point C), since it is desirable to measure the mix ratio of the mixture at a point closest to where the mixture is dispensed into the mould.

As used herein, the term “acoustic wave” preferably refers to an ultrasound wave having a frequency above the audible range of human hearing which is typically greater than 20 kilohertz. This disclosure also contemplates the use of other acoustic frequencies.

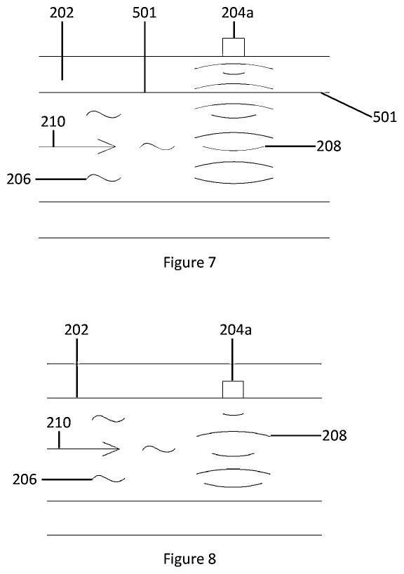

With reference to FIG. 7 there is an example where the transducer is located on an outer surface of the conduit 202. The emitted acoustic waves 208 are transmitted through a wall of the conduit 202 and across the phase boundary 501 between the solid wall and the mixture 206.

With reference to FIG. 8 there is an alternative example where the transducer 204a is embedded within the wall of the conduit and configured to emit the acoustic waves 208 directly into the mixture 206. Furthermore, and not shown, the transducer 204a and/or receiver 204b may protrude within the conduit 202.

A test of the method according to this disclosure will now be described. Any of the method steps or apparatus discussed in relation to the test may be incorporated into the aspects of this disclosure.

The test utilised a transducer arrangement in accordance with FIG. 2 discussed above. The tested resin was AIC Vicast® A717-LBB and the tested hardener was NOROX®PD-40 Acetyl Acetone peroxide. The resin and hardener was mixed together with the resulting mixture 206 being directed through the conduit 202. Four repeat measurements were carried out utilising different concentrations of the tested resin and hardener-1%, 2%, 3% and 4% mix ratios of hardener to resin. Each measurement was taken over a time period of 60 seconds. During each measurement, the transducer 204a was controlled to emit an acoustic wave at an ultrasonic frequency (i.e. an ultrasound wave) across the conduit 202. The ultrasound wave was reflected off an opposing wall of the conduit 202 from the transducer 204a and was received by the same transducer 204a acting as a receiver. The transducer 204a converted the ultrasound wave into a signal that was subsequently provided to the controller 101. The controller 201 processed the signal to determine the time of flight of the ultrasound wave 208 through the mixture 206. The controller 201 undertook multiple measurements across a 60 second time period at a frequency of 160 Hz. A median average value of the measurements across each 60 second time period was taken as a determination of the time of flight at the respective mixture concentration. It would be appreciated that a mean or mode average value may alternatively be used.

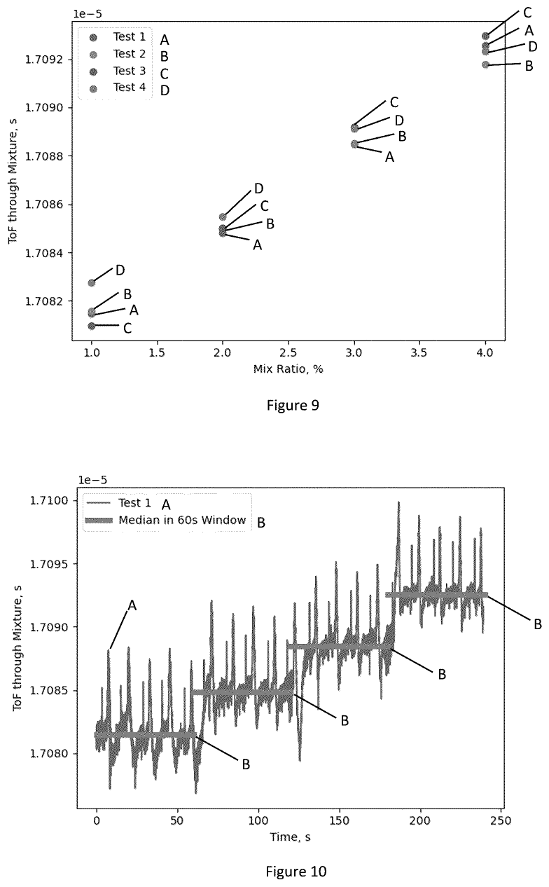

FIG. 9 indicates the result of the test. Each data point is a median average value of the measurements taken across a 60 second time period. It is observed that the time of flight (ToF) increases roughly linearly depending on the mix ratio %. It is shown that the ToF varies depending on the mix ratio and therefore the mix ratio can be monitored by monitoring of the ToF. The data shown in FIG. 9 may form the basis of an acoustic signature as discussed above. For example, it is known that a ToF of 1.7085 seconds for the configuration of the test is indicative of a mix ratio of 2%. Therefore, the acoustic signature can be compared with a detected acoustic wave to obtain an estimate of the mix ratio of the mixture.

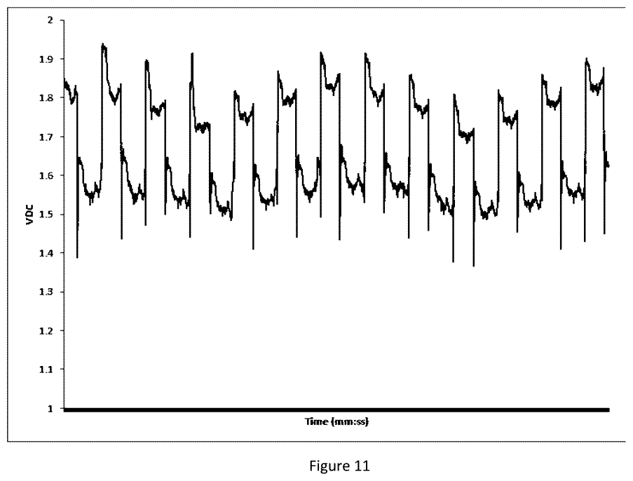

FIG. 10 indicates the raw results of the test. The curve A of FIG. 10 indicates the ToF measurements for test 1 of FIG. 9. Starting from 0 seconds, the first 60 second period is for a mix ratio of 1%, the second 60 second period is for a mix ratio of 2%, the third 60 second period is for a mix ration of 3%, and the fourth 60 second period is for a mix ratio of 4%. The ToF measurements have a cyclical nature during each 60 second period, hence why it is appropriate to take the average ToF value for the entire 60 second period as represented by the lines B. It has been found that the cyclical nature of the ToF value corresponds with the pressure fluctuations of the mixture that arise due to the pumping method utilised to move the mixture 206 through the conduit 202. Turning to FIG. 11, a plot of the pressure fluctuations as obtained from the pressure sensor 209 is observable (at a longer time scale compared to the plot of FIG. 10). The plot of FIG. 11 indicates a large fluctuation in pressure due to the pumping mechanism. The ToF measurements of FIG. 10 comprise different sizes of fluctuations and therefore it is shown that the ToF measurements of FIG. 10 are not simply an effect of pressure. It is further shown that in some implementations it is suitable to take an average value of any detection of the acoustic wave to account for any effect of fluctuations in the pressure of the mixture 206. The frequency of detections may be determined based on a frequency of expected pressure fluctuations.

In one example, it may be known from previous testing/calibration that the speed of sound through pure resin is Cᵣ and that the speed of sound through pure catalyst is C_{c}. The total speed of sound measured through the mixture of resin and catalyst, e.g. via the transducer arrangement discussed above, is Cₜ. The desired ratio of catalyst to resin is referred to as R_{c}. The following equations apply:

$${C}_{t} = {C}_{c} {R}_{c} + {C}_{r} ( 1 - {R}_{c} ) \qquad ( 1 )$$

$${R}_{c} = ( {C}_{t} - {C}_{r} ) / ( {C}_{c} - {C}_{r} ) \qquad ( 2 )$$

Utilising equation (2) it is possible to obtain a theoretical value of the mixing ratio R_{c} based on i) an acoustic signature comprising the known values of the speed of sound through the individual component materials and total mixture, and ii) a measured value of the speed of sound through the mixture Cₜ.

The theoretical value of R_{c} may require further processing to obtain a more accurate value of the mix ratio by taking account of factors such as the differing levels of attenuation through the materials, pressure/temperature of the flowing mixture, ongoing chemical reactions within the mixing, and a different in the chemical compounds between the materials (e.g. taking account of the resin being a long chain polymer).

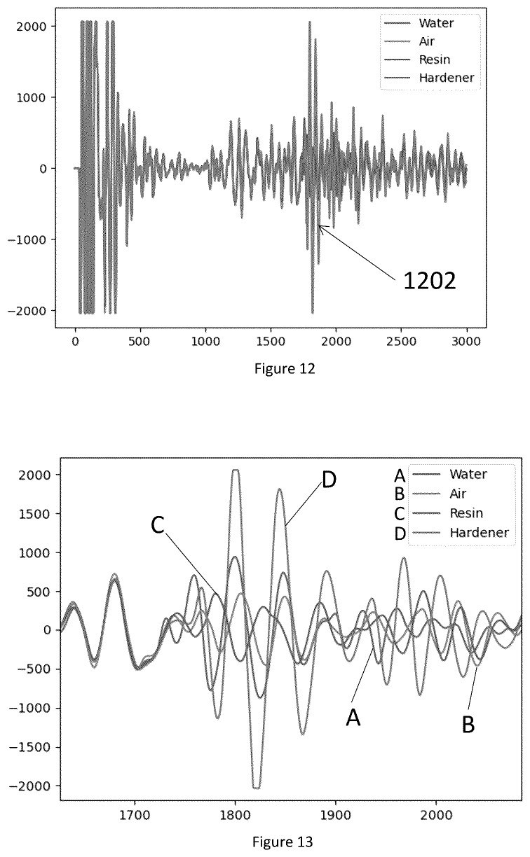

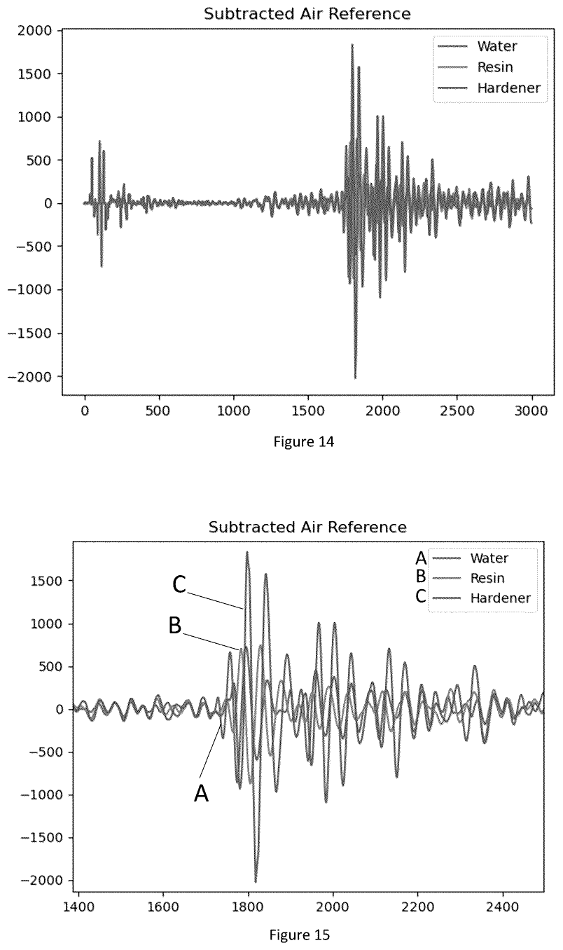

With reference to FIG. 12 there is a plot of an acoustic wave pulse 1202 received during a ToF measurement across a conduit such as the type discussed above. Each curve on the plot represents a waveform for when a different material flows through the conduit. The value of a ToF measurement is typically based on a zero crossing of the pulse waveform at a point where the amplitude has increased significantly beyond background noise. FIG. 13 is a close-up of a section of the plot of FIG. 12. for further clarifying the difference between the waveforms for different materials. FIGS. 14 and 15 indicate corresponding plots to that of FIGS. 12 and 13 respectively, after processing the waveforms to subtract the waveform for air. It can be observed, particularly with reference to FIGS. 12 and 14, that a significant amount of coherent noise is removed from the signals, thereby providing a clearer determination of when a pulse has been received and thus rendering it easier to obtain a ToF measurement.

The examples discussed above relate primarily to the use of time of flight as the acoustic signature for comparison to obtain monitoring data. However, this disclosure also relates to use of other parameters for the acoustic signature such as a level of attenuation of the acoustic wave through the mixture. This disclosure further relates to a frequency analysis of the detected acoustic wave by undertaking a Fast-Fourier transform and analysing the level of attenuation of specific frequencies.

It will be understood that the invention is not limited to the examples and embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A method of monitoring a mixing ratio of a mixture of materials flowing through a conduit in a composite material production process, the conduit being arranged between an inlet for receiving the mixture and a curing assembly, wherein the method comprises:
obtaining an acoustic signature of the mixture of materials;
controlling a transducer to emit an acoustic wave into the conduit;
controlling a receiver to detect the acoustic wave after propagation of the acoustic wave through the conduit; and
comparing an acoustic signature of the detected acoustic wave with the obtained acoustic signature to obtain monitoring data.

2. The method of claim 1, wherein the acoustic signature comprises an individual acoustic signature for each of the materials from the mixture of materials.

3. The method of claim 1, wherein the acoustic signature is a value for the time of flight of the acoustic signal, and wherein comparing the acoustic signature of the detected acoustic wave with the obtained acoustic signature comprises at least one of:
comparing values of the time of flight of the detected acoustic wave with an obtained time of flight;
comparing values of acoustic attenuation derived from the detected acoustic wave and the obtained acoustic signature; or
comparing a frequency spectrum derived from the detected acoustic wave and the obtained acoustic signature.

4. (canceled)

5. (canceled)

6. The method of claim 1, wherein controlling the transducer to emit the acoustic wave comprises:
emitting one or more of an acoustic pulse and a continuous acoustic wave.

7. The method of claim 1, wherein the transducer and receiver are a singular transceiver, the acoustic wave being emitted by the transceiver to be reflected from an interior wall of the conduit back to the transceiver.

8. The method of claim 1, wherein the transducer is controlled to transmit the acoustic wave to the receiver through the flowing mixture of materials.

9. The method of claim 1, wherein the transducer is controlled to emit the acoustic wave across an outer wall of the conduit to the flowing mixture therein.

10. The method of claim 1, wherein the receiver is controlled to detect the acoustic wave at each of a plurality of measurement time intervals, and wherein the method further comprises:
determining a mean parameter or average parameter of the acoustic wave across the plurality of measurement time intervals for comparison with the acoustic signature.

11. The method of claim 1, further comprising:
determining a value of the mixing ratio based on the monitoring data.

12. The method of claim 11, further comprising at least one of:
controlling a pressure sensor to detect the pressure of the mixture of materials, and wherein the value of the mixing ratio is additionally determined based on the detected pressure; or
controlling a temperature sensor to detect the temperature of the mixture of materials, wherein the value of the mixing ratio is additionally determined based on the detected temperature.

13. (canceled)

14. The method of claim 1, wherein the acoustic wave is emitted into the conduit at a location proximal the curing assembly.

15. The method of claim 1, wherein the mixture of materials comprises a resin and a catalyst for curing in the curing assembly to a solid composite component.

16. The method of claim 1, wherein obtaining the acoustic signature of the mixture of materials comprises;
emitting a test acoustic wave through each of the materials comprising the mixture of materials and receiving corresponding acoustic waves defining the acoustic signature.

17. The method of claim 1, further comprising:
transmitting the monitoring data to a remote processing device.

18. (canceled)

19. A non-transitory computer-readable medium comprising instructions which, when executed by a processor, cause an apparatus comprising the processor to carry out the method of claim 1.

20. An assembly arranged to monitor a mixing ratio of a mixture of materials flowing through a conduit in a composite material production process, the conduit being arranged between an inlet for receiving the mixture and a curing assembly, wherein the assembly comprises:
a transducer configured to emit an acoustic wave into the conduit;
a receiver configured to detect the acoustic wave after propagation of the acoustic wave through the conduit; and
a processor configured to compare an acoustic signature of the detected acoustic wave with an earlier obtained acoustic signature to obtain monitoring data.

21. The assembly of claim 20, wherein the transducer is arranged to emit one or more of an acoustic pulse and a continuous acoustic wave.

22. (canceled)

23. The assembly of claim 20, wherein the transducer and receiver are spatially separated from each other along the circumferential and/or the longitudinal direction of the conduit.

24. The assembly of claim 20, further comprising a plurality of transducers and/or receivers distributed along the conduit.

25. The assembly of claim 20, wherein the conduit is arranged between a mixing assembly and the curing assembly.
